(19) United States
(12) Patent Application Publication
(10) Pub. No.: US 2017/0274717 A1
(43) Pub. Date: Sep. 28, 2017

(54) JOINT LOCATOR

(71) Applicant: Jaguar Land Rover Limited, Coventry, Warwickshire (GB)

(72) Inventors: Mark Mansfield, Coventry, Warwickshire (GB); Andrew Elliott, Coventry, Warwickshire (GB); Adam Dickens, Coventry, Warwickshire (GB)

(21) Appl. No.: 15/507,135

(22) PCT Filed: Sep. 3, 2015
(86) PCT No.: PCT/EP2015/070110

§ 371 Date: Feb. 27, 2017

(30) Foreign Application Priority Data
Sep. 5, 2014 (GB) 1415711.9
Sep. 5, 2014 (GB) 1415713.5

(51) Int. Cl. B60G 7/00

(52) U.S. Cl. CPC B60G 7/008; F16B 2001/0092

(57) ABSTRACT

A locator (150) for positioning a male element (144) relative to a female element (142) in a joint (132), the male element (144) having a smaller footprint than the female element (142) and the locator (150) comprising an aperture (156) for receiving the male element (144), the aperture (156) having a smaller footprint than the female element (142) and locating means (164) for positioning the locator (150) relative to the female element (142) of the joint (132) such that the aperture (156) of the locator (150) selectively exposes only a part of the female element (142) to ensure location of the male element (144) within the female element (142) in a desired position. The locator (150) further comprises attachment means for attaching the locator (150) to the joint (132), wherein the attachment means is configured to detach on application of a threshold force. The invention therefore provides a simple means of reliably positioning a male element (144) in a desired position relative to a female element (142) in a joint during an initial installation stage without the need to visualise the joint (132). The invention is particularly applicable to a joint (132) in a vehicle suspension system between a frame (132) and a bolt (145) that supports a control arm (16).

### TECHNICAL FIELD

The invention relates to a joint locator for locating a male element relative to a female element in a joint, the male element having a smaller footprint than the female element. In particular, but not exclusively, the invention relates to a joint locator for use in a suspension system of a vehicle.

### BACKGROUND

High load events such as a vehicle striking a kerb or pothole may result in damage to vehicle suspension components such as ball joints or control arms. The ball joints are the connection between the control arms of the vehicle suspension system and the steering knuckle, which connects the wheel hub to the suspension system. Damaged ball joints, for example, may initially go undetected by the driver as in many cases they produce no discernible symptoms. However, damage to the ball joints can result in the ball joints failing due to fatigue. Failure of a ball joint can render the vehicle inoperable until such time as the ball joint and any other vehicle components damaged as a result of the failure are repaired.

In a multilink front suspension system having compression and lateral lower control arms, it is known in the prior art to make one of the arms collapsible by provision of a kink in the arm. For example, the kinked arm may be designed to collapse upon high sideways loading to absorb loads in the event of a side impact. The collapsed control arm must be replaced during repair of the suspension system, and in some cases the collapsed control arm may render the vehicle un-driveable until such time as the suspension system has been repaired. Replacement of the collapsed control arm and repair of the suspension system is expensive and it is inconvenient if the vehicle is un-driveable in the meantime.

### SUMMARY OF THE INVENTION

Against this background, the invention resides in a locator for positioning a male element relative to a female element in a joint, the male element having a smaller footprint than the female element and the locator comprising: an aperture for receiving the male element, the aperture having a smaller footprint than the female element. The locator comprises an aperture for receiving the male element, the aperture having a smaller footprint than the female element, and locating means for positioning the locator relative to the female element of the joint whereby the aperture of the locator selectively exposes only a part of the female element to ensure location of the male element within the female element in a desired position. The locator further comprises attachment means for attaching the locator to the joint, wherein the attachment means is configured to detach on application of a threshold force.

When the locator is in place in the joint, the aperture of the locator exposes only a part of the female element such that the male element can only be inserted in the desired position relative to the female element. The invention therefore provides a simple means of reliably positioning a male element in a desired position relative to a female element in a joint during an initial installation stage without the need to visualise the joint.

Enabling the attachment means to detach from the joint in this way means that once a threshold force has been applied, the locator, and thus a male element supported by the locator, may be free to move within the female element of the joint. The ability of the male element to move freely within the female element can be detected by non-visual means (for example, in the specific application of a vehicle suspension joint, by altering the steering of the vehicle, such as by giving a limited angular displacement of the steering wheel) thereby allowing an observer to determine that the threshold force has been exceeded without a need to visualise the joint.

The locating means may also be the attachment means. In this way, the locator can be both positioned in the required location, and attached to the joint in a single procedure, thereby facilitating installation of the locator in the joint. Furthermore, the number of features on the locator may be reduced, facilitating manufacture of the locator.

The locating means may comprise a protrusion for locating in an aperture or recess disposed in the vicinity of the female element. In this way, the locating means can easily be formed on the locator, and can securely locate the locator in the desired position.

The locator may comprise retaining features for fixing an orientation of the locator with respect to the female element. The retaining features guard against movement of the locator about the attachment means and away from the desired position, for example by hindering rotation of the locator about the attachment means.

For ease of manufacture of the locator, the retaining features may be lugs that extend into the female element when the locator is in use. Advantageously, the lugs protrude from the locator, such that if one of the lugs is not located correctly in the female element, the lug sits against the joint, preventing the locating means being correctly positioned relative to the joint, and signalling to the operator that the locator needs to be repositioned.

The attachment means may comprise cooperable attachment formations. The cooperable attachment formations maybe engageable by means of a push fit. A push-fit allows simple engagement of the cooperable attachment formations without the need for additional tools, or the need to visualise the attachment formations in order to effect the engagement. The cooperable attachment formations comprise male and female attachment formations.

The locator may comprise a flexible portion disposed between the cooperable attachment formations. In this way, the locator can easily be folded about the flexible portion to allow engagement of the cooperable attachment formations.

To increase flexibility of the flexible portion, at least a part of the flexible portion may be thinner than a remainder of the locator. Additionally or alternatively, the flexible portion may comprise a corrugated section to increase flexibility further.

The locator may comprise reinforcing means around the aperture to increase the integrity of the joint.

The locator may comprise a frame for supporting the reinforcing means.

The reinforcing means may be insertable into the frame by a push fit. Alternatively, the reinforcing means may be fixed into the frame by adhesive, or during the manufacturing process. In other embodiments, the frame and the reinforcing means may be integrally formed.

The reinforcing means may be a disc that comprises the aperture. For example, the reinforcing means may be a washer.

The frame may comprise a tab portion that supports the locating means. In this way, the frame can be made from a material that is less expensive than the reinforcing means, and that can be easily moulded to form the locating features of the locator.

According to an aspect of the present invention there is provided a locator for positioning a male element relative to a female element in a joint, the male element having a smaller footprint than the female element and the locator comprising: an aperture for receiving the male element, the aperture having a smaller footprint than the female element; and a locating arrangement for positioning the locator relative to the female element of the joint such that the aperture of the locator selectively exposes only a part of the female element to ensure location of the male element within the female element in a desired position. The locator may comprise an attachment formation for attaching the locator to the joint. The locating arrangement may also be the attachment formation. Optionally the attachment formation is configured to detach on application of a threshold force.

The invention also extends to a joint comprising a female element, a male element received in the female element, the male element having a smaller footprint than the female element, and a locator having an aperture for receiving the male element, the aperture having a smaller footprint than the female element. A locating means of the locator cooperates with a locating means in the vicinity of the female element, whereby the locator is positioned such that the aperture selectively exposes a part of the female element so as to locate the male element in a desired location relative to the female element in the joint.

The female element may be a slot.

The locator may be attached to the joint in the vicinity of the female element. In particular, the locator may be attached to a frame that supports the female element. In this case, the locating means in the vicinity of the female element may be an aperture provided in the frame. The locating means may act as an attachment means for receiving the attachment means of the locator.

The locator may comprise attachment means for attaching the locator in the vicinity of the slot.

The frame may comprise an attachment means for attaching the locator to the frame. For simplicity, the attachment means of the frame may be an aperture for receiving attachment means of the locator.

The locator of the joint may be the locator described above.

The joint may be a joint in a suspension system of a vehicle.

The invention also extends to a suspension system in a vehicle comprising the joint described above.

The suspension system may further comprise a control arm mounted at a first end to a frame portion of the vehicle, wherein at least a portion of the control arm is arranged to slide relative to the frame portion when the control arm is subjected to loads exceeding a predetermined level. The system may further comprise a retaining means configured to prevent the control arm from sliding relative to the frame portion when the control arm is subjected to loads below the predetermined level.

The retaining means may comprise the locator described above.

The control arm may comprise the male member as described above.

The frame portion of the vehicle may comprise the female element as described above.

The invention extends further to a method of assembling a joint using a locator, the joint comprising a female element and a male element having a smaller footprint than the female element, the locator comprising an aperture having a smaller footprint than the female element and the method comprising:
arranging the locator such that the aperture of the locator selectively exposes a portion of the female element;
attaching the locator to the joint; and
inserting the male element into the female element through the aperture of the joint locator.

The method may comprise attaching the locator to the joint before inserting the male element into the female element through the aperture of the joint locator.

According to an aspect of the present invention, there is provided a locator for positioning a male element relative to a female element in a joint, the male element having a smaller footprint than the female element. The locator comprises an aperture for receiving the male element, the aperture having a smaller footprint than the female element, and locating means for positioning the locator relative to the female element of the joint whereby the aperture of the locator selectively exposes only a part of the female element to ensure location of the male element within the female element in a desired position.

According to a yet further aspect of the present invention, there is provided a vehicle suspension system comprising a control arm mounted at a first end to a frame portion of a vehicle, wherein at least a portion of the control arm is arranged to slide relative to the frame portion when the control arm is subjected to loads exceeding a predetermined level, the system further comprising retaining means configured to prevent the control arm from sliding relative to the frame portion when the control arm is subjected to loads below the predetermined level.

When the suspension system is subject to a high load event, for example if the vehicle hits a kerb or pothole at speed or when braking, the control arm slides relative to the frame portion of the vehicle. In an embodiment of the invention, the system is configured such that loads in excess of approximately 60 kN cause the control arm to slide. As the control arm slides, it absorbs some of the impact of the high load event, and thus protects other components of the vehicle and suspension system from damage. For example, the novel and inventive sliding arrangement of the present invention serves to protect the ball joints from sustaining damage. Furthermore, by sliding, the control arm itself is less likely to break or become damaged during high load events, thus reducing repair costs.

In a particularly advantageous arrangement of the present invention, when the control arm slides, it causes a permanent angular displacement of the steering wheel of the vehicle. This is an immediate signal to the driver that the vehicle requires attention following a high load event. However, the vehicle advantageously remains driveable after the event, and with substantially no negative effect on the control of the vehicle, so the driver can safely drive the vehicle to a service station to be checked and repaired. This is an advantage over collapsible suspension arrangements which could render the vehicle inoperable after a high load event.

The system may be configured to cause a permanent angular displacement of the steering wheel of between 5 to 15 degrees. The angular displacement maybe between 7 to 12 degrees. The inventors of the present invention have determined that an angular displacement of seven degrees or more is readily noticed by the driver. The angular displacement should be minimised, whilst remaining noticeable, in order not to adversely affect the control of the vehicle. The inventors have determined that an angular displacement of 12 degrees is a suitable upper limit whereby the driver's control over the vehicle is not substantially affected.

Upon servicing the suspension system, critical components such as the ball joints may be checked for damage and replaced or repaired if necessary and the sliding arrangement between the control arm and the frame portion can be reset to the factory setting. In contrast to prior art suspension arrangements where high impact events may cause no discernible symptoms at first but may later cause a fatigue failure, the present invention may advantageously cause a benign fault (for example misalignment of the steering wheel), which signals to the driver that the vehicle requires specialist attention. Subsequent fatigue failures may therefore be substantially avoided as a result of the present invention.

According to another aspect of the invention, there is provided a vehicle comprising the vehicle suspension system as set out in the previous aspect.

A second end of the control arm could be mounted directly or indirectly to a knuckle, e.g. a steering knuckle. The control arm may be configured to slide relative to the frame portion in a sliding direction generally parallel to an axis defined by a straight line extending between the first and second ends of the control arm. The control arm may be straight, in which case the axis may extend along a body of the control arm, or the control arm may be curved, for example a so-called ‘banana arm’.

In an embodiment of the present invention, the first end of the control arm is slidably mounted to the frame portion of the vehicle. The first end of the control arm may be pivotally connected to the frame portion, for example via a bushing, such that the control arm is able to pivot relative to the frame portion about a pivot axis. The sliding motion between the control arm and the frame portion may cause a displacement of the pivot axis in a sliding direction.

The frame portion of the vehicle may comprise a slot through which the first end of the control arm is connected to the frame portion. The control arm may be arranged to slide along the slot when subjected to a load exceeding the predetermined level. The frame portion may comprise a pair of opposed slots. The first end of the control arm may be connected between the pair of slots and be slidable along the pair of slots when subjected to a load exceeding the predetermined level. The frame portion could be a clevis and the slots are provided respectively in mutually-opposed side walls of the clevis.

The retaining means may be configured to exert a clamping force between the control arm and the frame portion. The clamping force could be sufficient to prevent the control arm from sliding relative to the frame portion when the control arm is subjected to loads below the predetermined level, but insufficient to prevent the control arm from sliding relative to the frame when the control arm is subjected to loads exceeding the predetermined level. In an embodiment of the invention, the retaining means comprises a nut and bolt assembly.

The retaining means may comprise a deformable component configured to deform when the control arm is subjected to loads above the predetermined level. For example, the retaining device may comprise a washer having a tab extending from its periphery. The tab may be bent and engages with a locating feature defined in the frame portion adjacent the slot. The tab may be configured to straighten when the control arm is subjected to loads exceeding the predetermined level thereby permitting the control arm to slide along the slot(s).

In a particular embodiment, the retaining device comprises a plate arranged flush with the frame portion. The plate has an aperture through which the bolt extends, and the plate further comprising a slot extending substantially parallel to the slot defined in the frame portion. The plate may be clamped to the frame portion via one or more fasteners located in the slot in the plate. In a particular example these fasteners are rivets and serve to connect the plate in a predetermined position relative to the vehicle frame. Accordingly, the plate provides a convenient locating device that enables the control arm to be correctly positioned in the slot(s) in the frame portion when the suspension system is initially set or when it is reset after a high load event. The suspension system could be for a front wheel of the vehicle. In an embodiment the control arm is a front lower control arm. The suspension system may be a multilink suspension system and the control arm may be a compression arm.

The inventive concept encompasses a vehicle comprising the suspension system described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a front view of a front sub-frame of a vehicle to which a front suspension system according to an embodiment of the present invention is mounted;

FIG. 2 is a bottom view of the front sub-frame of FIG. 1;

FIG. 3 is a perspective view of first and second lower control arms of the suspension system according to an embodiment of the present invention, in which an end of the first control arm is slidably mounted to a clevis portion of the front sub-frame;

FIG. 4 is a close-up perspective view of the clevis portion of the front sub-frame prior to attaching the first control arm and showing a pair of slots provided in the side-walls of the clevis portion;

FIG. 4A is a schematic representation of one of the slots, which illustrates the shape and size of the slot;

FIG. 5 is a close-up perspective view of the clevis with the control arm attached;

FIG. 6 is a cross-sectional plan view of the clevis and attached first control arm;

FIG. 7 is a side view of the clevis and the attached first control arm, indicating the direction in which the control arm is slidable relative to the sub-frame;

FIG. 8 is a plan view of the clevis and the attached first control arm, indicating the direction in which the control arm is slidable relative to the sub-frame;

FIG. 9 is a perspective view of a further embodiment of the present invention in which the system further comprises a deformable tab washer; and

FIG. 10 is a perspective view of yet another embodiment of the present invention in which the system further comprises a pressed plate attached to the clevis by rivets.

FIG. 11A, is a perspective view of a frame forming part of a suspension joint in a vehicle;

FIG. 11B is a perspective view of a suspension joint in a vehicle.

FIG. 12A is a perspective view from the front of a locator in use in locating a male element relative to a female element in a joint;

FIG. 12B is a schematic cross-sectional view of the male and female elements of the joint of FIG. 12A;

FIG. 13 is a cross-sectional view of the joint of FIG. 12A;

FIG. 14 is a perspective view from the rear of a frame having a slot and forming part of the joint of FIG. 12A;

FIG. 15 is a perspective view from the rear of the locator of FIG. 12A;

FIGS. 16A and 16B are perspective views from the front and the rear respectively of the frame of FIG. 4 with a locator fixed to the frame ready for use in locating a bolt relative to the slot of the frame;

FIGS. 17 to 20 illustrate steps in a method of locating a male element relative to a female element in a joint using the locator of FIG. 14;

FIG. 21 is a cross-sectional view of another locator for use in locating a male element relative to a female element in a joint; and

FIGS. 22A and 22B are perspective views of another locator.

Throughout the description, terms such as ‘upper’, ‘lower’, ‘left’, ‘right’ and so on relate to the orientation of the locator and the joint as shown in the accompanying drawings. It will be appreciated, however, that the locator may be used in any suitable orientation.

### DETAILED DESCRIPTION

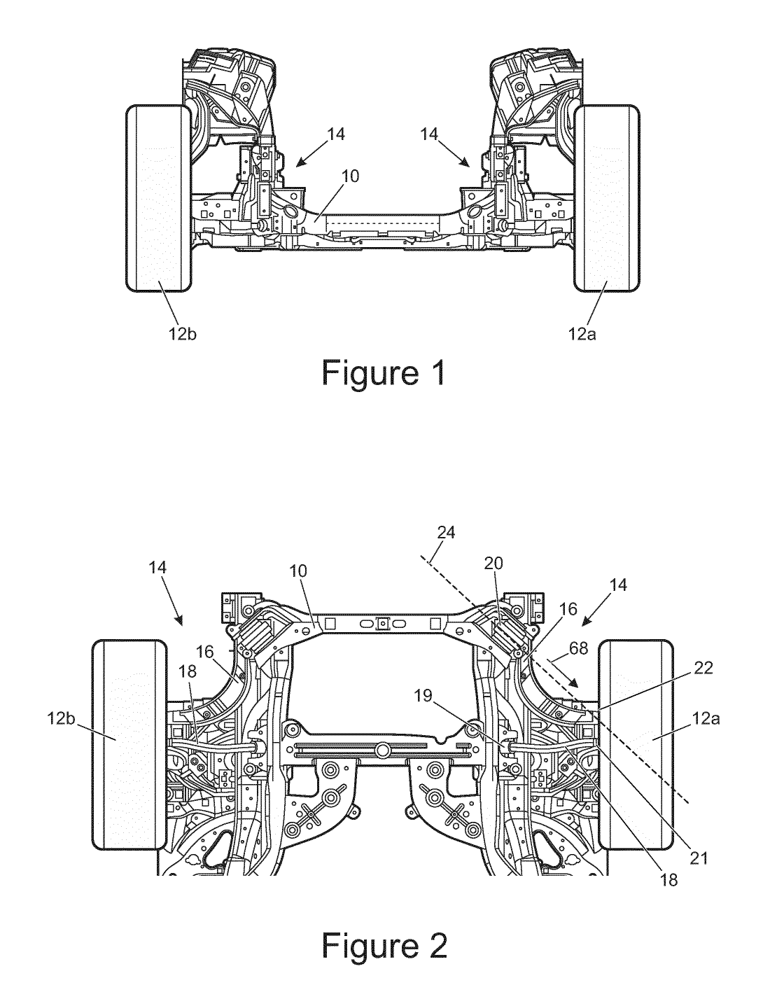

Referring to FIG. 1, this shows a front sub-frame 10 of a vehicle (in this case a car) as viewed from the front. A front-left wheel 12a and a front-right wheel 12b are located adjacent to the sub-frame 10. Each wheel 12a, 12b is mounted to the sub-frame 10 via an associated front suspension system 14 according to an embodiment of the present invention.

Referring now to the bottom view of FIG. 2, the front suspension system 14 in this example is a multilink suspension system comprising first and second lower control arms 16, 18. The first control arm 16 is also referred to herein as the ‘compression arm’, and has a generally curved shape. This arm 16 is sometimes referred to as a ‘banana arm’ in view of its curved shape. The second arm 18 is also referred to herein as the ‘lateral arm’ and is generally straight and extends in a lateral (i.e. width wise) direction between the associated wheel 12a, 12b and the sub-frame 10. The control arms 16, 18 are each connected at a first end 19, 20 to the sub-frame 10 and at a second end 21, 22 to a steering knuckle, to which the wheels 12a, 12b are mounted. The steering knuckles are obscured by the wheels 12a, 12b in FIG. 2.

A dashed line 24 extending between the first and second ends 20, 22 of the compression arm 16 is shown on FIG. 2, and the significance of this line will be explained later.

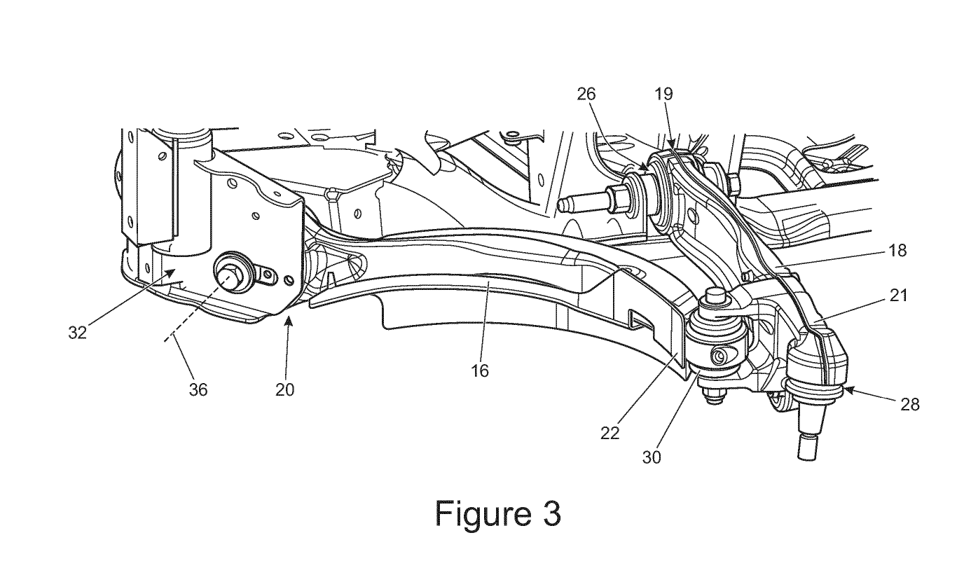

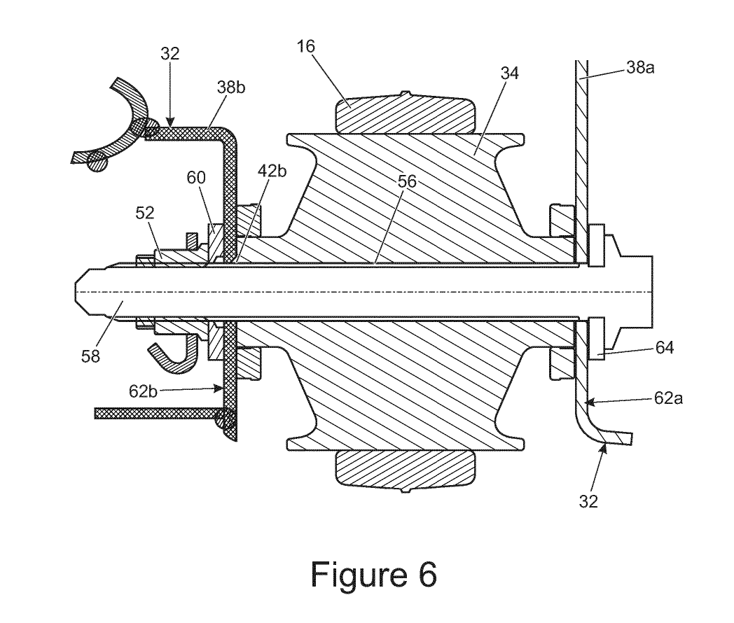

Referring now to the perspective view of FIG. 3, this shows the first and second control arms 16, 18 of the suspension system 14 for the front-left wheel 12a. The lateral arm 18 is connected at its first end 19 to the sub-frame 10 via a rubber bushing 26, which allows the lateral arm 18 to pivot up and down relative to the sub-frame 10. The second end 21 of the lateral arm 18 comprises a ball joint 28, which connects to the steering knuckle. The second end 22 of the compression arm 16 also connects to the second end 21 of the lateral arm 18 via a rubber bushing 30, which allows the compression arm 16 to pivot relative to the lateral arm 18. Hence the compression arm 16 is indirectly connected to the steering knuckle in this example. The first end 20 of the compression arm 16 is connected to a clevis portion 32 of the sub-frame 10 via a rubber bushing 34 (visible in FIG. 6), which allows the compression arm 16 to pivot up and down relative to the sub-frame 10 about a pivot axis 36.

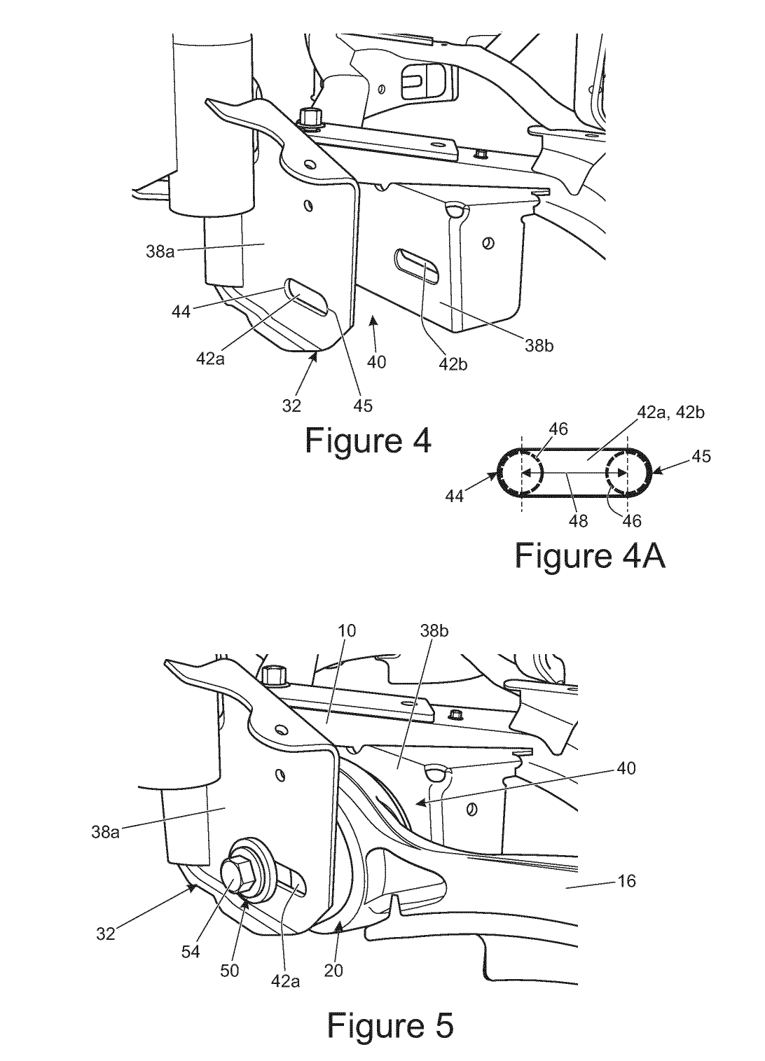

Referring now to FIG. 4, the clevis portion or frame portion 32 of the sub-frame 10 comprises a pair of mutually opposed and spaced-apart side walls 38a, 38b defining a gap 40 in between. A slot 42a, 42b is provided in each of these side walls 38a, 38b. The slots 42a, 42b are in the form of elongate apertures which extend completely through the thickness of the side walls 38a, 38b of the clevis 32. The slots 42a, 42b are arranged opposite one another in the respective side walls 38a, 38b of the clevis 32. Referring to FIG. 4A, this shows the shape and size of the slots 42a, 42b. The slots 42a, 42b have rounded first and second ends 44, 45 which are part circular. The length of the slots in this example is 28 millimetres between the centres of the circles 46 defining the respective part-circular ends 44, 45 of the slots 42a, 42b, as shown by the double-headed arrow 48 in FIG. 4A.

Referring now to FIG. 5, this shows the first end 20 of the compression arm 16 attached to the clevis portion 32 of the sub-frame 10. The first end 20 of the compression arm 16 is located in the gap 40 defined between the opposed side walls 38a, 38b of the clevis 32. A fastener 50 in the form of a nut 52 (shown in FIG. 6) and bolt 54 is used to attach the compression arm 16 to the clevis 32. Referring also to the cross-sectional view of FIG. 6, the bolt 54 extends through the pair of opposed slots 42a, 42b defined in the respective side walls 38a, 38b of the clevis 32, and through a central bore 56 defined in the rubber bushing 34 of the compression arm 16. The pivot axis 36 between the control arm 16 and the clevis 32 is defined by the longitudinal extension of the bolt 54 and is shown by the horizontal dashed-dot line in FIG. 6. The nut 52 is provided on a threaded end 58 of the bolt 54 and a first washer 60 is provided between the nut 52 and an outer surface 62b of a second side wall 38b of the clevis 32. A second washer 64 is provided between a head 66 of the bolt 54 and an outer surface 62a of a first side wall 38a of the clevis 32.

When the compression arm 16 is initially attached to the clevis 32, the bolt 54 is located at a first position in the slots 42a, 42b, which in this example is at the first ends 44 of the slots 42a, 42b, as shown in FIG. 5. The nut 52 is tightened to clamp the compression arm 16 to the sub-frame 10, i.e. to clamp the first end 20 of the compression arm 16 between the opposed side walls 38a, 38b of the clevis 32. Referring again to FIG. 6, the bushing 34 allows the compression arm 16 to pivot up and down relative to the clevis 32 when the nut 52 is tightened. The nut 52 is tightened to a predetermined torque level which prevents the compression arm 16 from sliding in the slots 42a, 42b when the suspension system 14 is subjected to normal load levels. In this example the torque level is approximately 200 Nm. Normal load levels are levels that do not generally cause damage to the suspension components. Hence, under normal load levels the bolt 54 remains at the first ends 44 of the slots 42a, 42b as shown in FIG. 5.

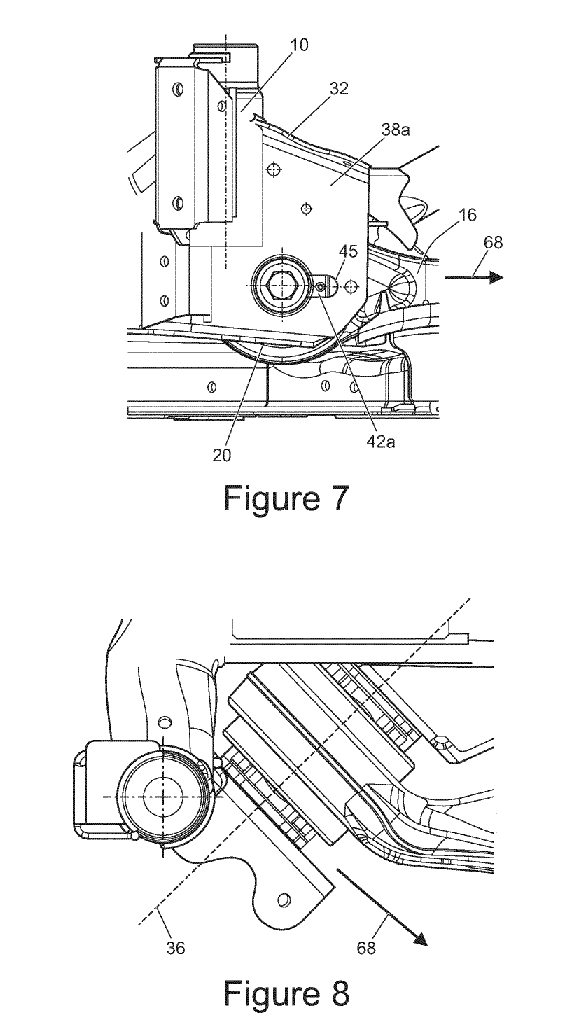

In the event that the suspension is subjected to a high load event, for example if the vehicle hits a kerb or pothole, then the force of the impact may be sufficient to overcome the clamping force of the nut and bolt fastener 50. If this occurs, then the first end 20 of the compression arm 16 slides along the slots 42a, 42b towards a second position at the second ends 45 of the slots. In this example, loads in excess of approximately 60 kN will cause the compression arm 16 to slide along the slots 42a, 42b. Referring to the side view of FIG. 7, this shows the first end 20 of the compression arm 16 in the first position along the slots 42a, 42b, and the arrow 68 indicates the direction of sliding in a high load event.

Likewise in the plan view of FIG. 8, the arrow 68 indicates the direction of sliding in a high load event. Here it can be seen that sliding motion of the control arm 16 relative to the sub-frame 10 causes displacement of the pivot axis 36 in the sliding direction 68. Referring also again to FIG. 2, the sliding direction 68 is generally parallel to the dashed line 24 in FIG. 2, which is the straight line extending between the first and second ends 20, 22 of the compression arm 16.

In prior art systems, which do not incorporate a sliding connection between the control arms and the sub-frame, such a high load event may cause the control arm to break or buckle or cause damage to the ball joints for example. However, the sliding arrangement of the present invention is able to absorb some of the impact of a high load event, which advantageously protects the ball joints and the control arms from becoming damaged in such events.

When the control arm 16 slides to the second position, this results in a permanent angular displacement of approximately seven degrees in the steering wheel of the vehicle. This is an immediate sign to the driver that the vehicle requires attention. The vehicle is still drivable, which allows the driver to drive the vehicle to a service centre rather than the vehicle requiring recovery. During service, the ball joints 28 (FIG. 3) and other suspension components can be examined and replaced or repaired if required. The sliding connection between the compression arm 16 and the clevis 38 is also reset by positioning the compression arm 16 at the first position in the slots 42a, 42b and re-tightening the nut 52 (FIG. 6) to the predetermined torque level.

The present invention represents a significant advantage over prior art systems where damage to the suspension components may go undetected as there may be no symptoms of damage after a high load event. Such prior art systems therefore are more vulnerable to fatigue failures, which can be dangerous and leave the vehicle inoperable and requiring recovery. The offset steering wheel provides an immediate visual indication to the driver that the vehicle requires attention, and hence the suspension can be assessed to check whether any of the components are damaged. The driver will also be able to feel the effects of the offset steering through the wheel. By absorbing impact in the sliding mechanism, the suspension components are less likely to incur damage in high load events with the present invention and hence repair costs are reduced.

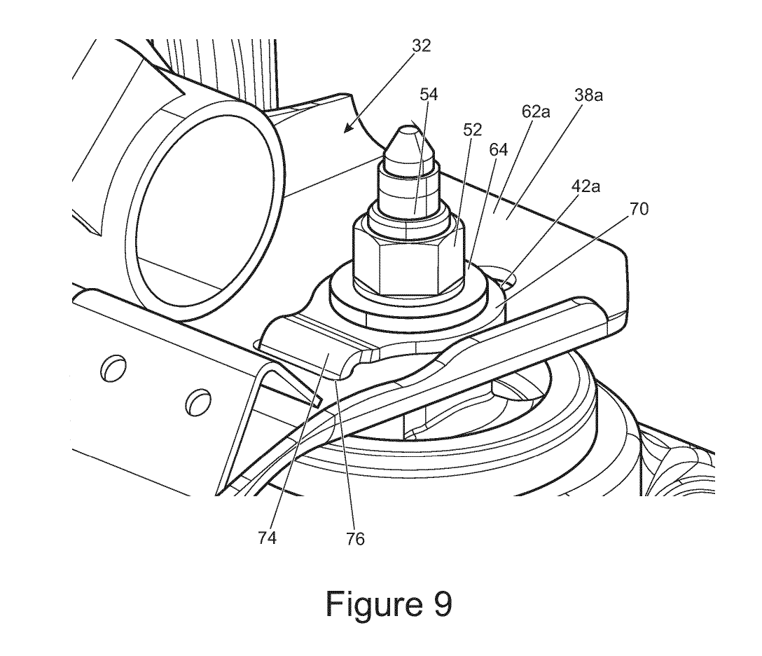

Referring to FIG. 9, this shows a further embodiment of the present invention. The further embodiment is otherwise identical to the other embodiment, but includes an additional metal tab washer 70 having an annular body 72 with a tab 74 protruding from its outer periphery. Also, it will be appreciated that FIG. 9 shows the bolt 54 extending in the reverse direction compared to the other embodiment, i.e. so that the nut 52 is adjacent to the first side wall 38a of the clevis 32, although it should be appreciated that the orientation of the bolt 54 in all embodiments is interchangeable.

In this embodiment, the first side wall 38a of the clevis 32 also includes an aperture 76 adjacent the slot 42a. The tab washer 70 is provided between the nut 52 and the outer surface 62a of the first side wall 38a of the clevis 32. A further washer 64 is provided between the tab washer 70 and the nut 52. The tab washer 70 has a first configuration in which the tab 74 is bent and extends through the aperture 76 adjacent the slot 42a. As shown in FIG. 9, the bent tab 74 forms a hook that hooks around the first side wall 38a of the clevis 32 in the aperture 76. The tab washer 70 conveniently serves to locate the bolt 54 correctly in the first position when the suspension system 14 is set in the factory or during servicing. A similar tab washer may be provided on the other side of the clevis, i.e. between the bolt head and the outer surface of the second side wall of the clevis.

The tab 74 is a deformable and is configured to deform such that it straightens when the suspension system 14 is subjected to a load exceeding a predetermined level (i.e. a high load event). The straightened tab permits the first end of the compression arm 16 to slide in the slots 42a, 42b as described above in relation to the other embodiment. The straightened tab is also referred to as a ‘second configuration’ of the tab 74. When subjected to loads below the predetermined level, the tab 74 remains in the bent first configuration and additionally allows the tab washer 70 to act as a retaining means by serving to retain the compression arm 16 in the first position with respect to the slots 42a, 42b and thus preventing sliding of the arm 16 relative to the sub-frame 10. The tab washer 70 is an optional feature as the nut 52 and bolt 54 can provide sufficient clamping force to prevent sliding under normal conditions (i.e. the other embodiment). However, as well as providing a convenient locating feature, the tab washer 70 can provide an additional safe guard to prevent sliding under normal loads or to allow lower torque levels to be applied to the nut 52. The tab washer 70 will require replacing during repair/resetting of the suspension system 14.

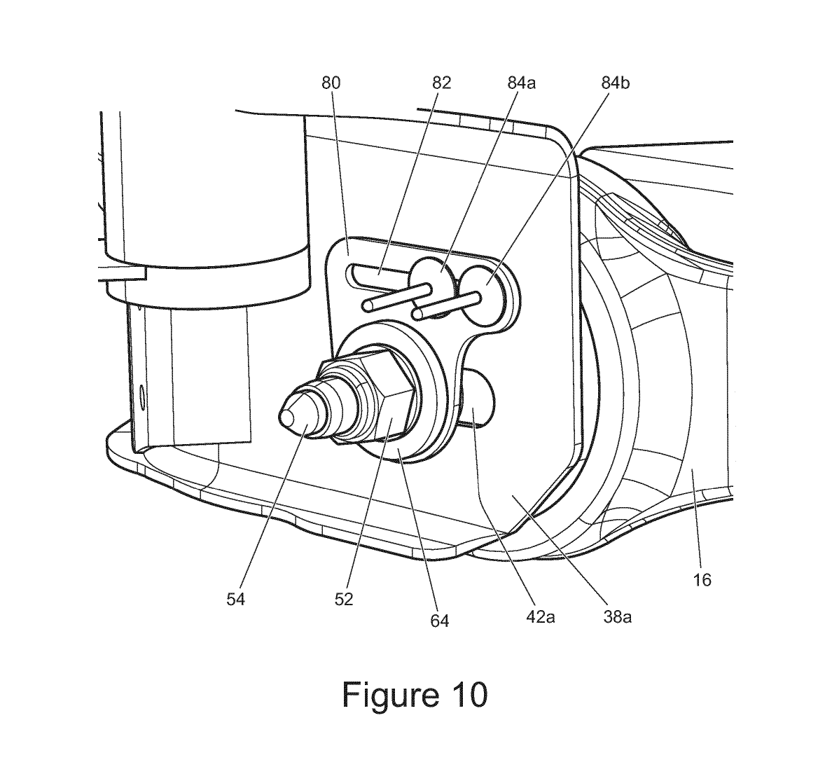

Referring now to FIG. 10, this shows a yet another embodiment of the present invention in which a pressed metal plate 80 is provided between the nut 52 and the first side wall 38a of the clevis 32. Again, a further washer 64 is provided between the nut 52 and the pressed plate 80. The pressed plate 80 includes a slot 82 extending parallel to the slot 42a in the side wall 38a of the clevis 32. The pressed plate 80 is riveted to the side wall 38a of the clevis 32 by first and second rivets 84a, 84b, which extend through apertures in the side wall 38a and through the slot 82 in the plate 80. The rivets 84a, 84b in combination with the nut and bolt act as retaining means, only allowing the compression arm 16 to slide in the slot 82 when a load exceeding predetermined level is applied. Again, a similar plate may be provided on the other side of the clevis 32. The plate(s) 80 provide a convenient locating feature allowing the bolt 54 to be correctly set in a first position when the suspension is assembled, adjusted or repaired.

Many modifications may be made to the above examples without departing from the scope of the invention as defined in the accompanying claims. For example, rather than providing slots that extend through the entire thickness of the clevis, the clevis may be provided with suitable grooves extending along the inner surfaces of the opposed side walls, and instead of a nut and bolt assembly, the control arm could be attached to the grooves by a rod that engages at each end with one of the grooves. The rod may be a spring bar biased towards an extended configuration, similar to a watch strap pin, albeit more robust. Accordingly, it will be appreciated that neither the slots nor the nut and bolt assembly are essential elements of the invention and other alternative arrangements are possible. Whilst embodiments shown in the figures include a sliding connection between the control arm and the sub-frame, in other embodiments the control arm may have two sections joined by a sliding linkage.

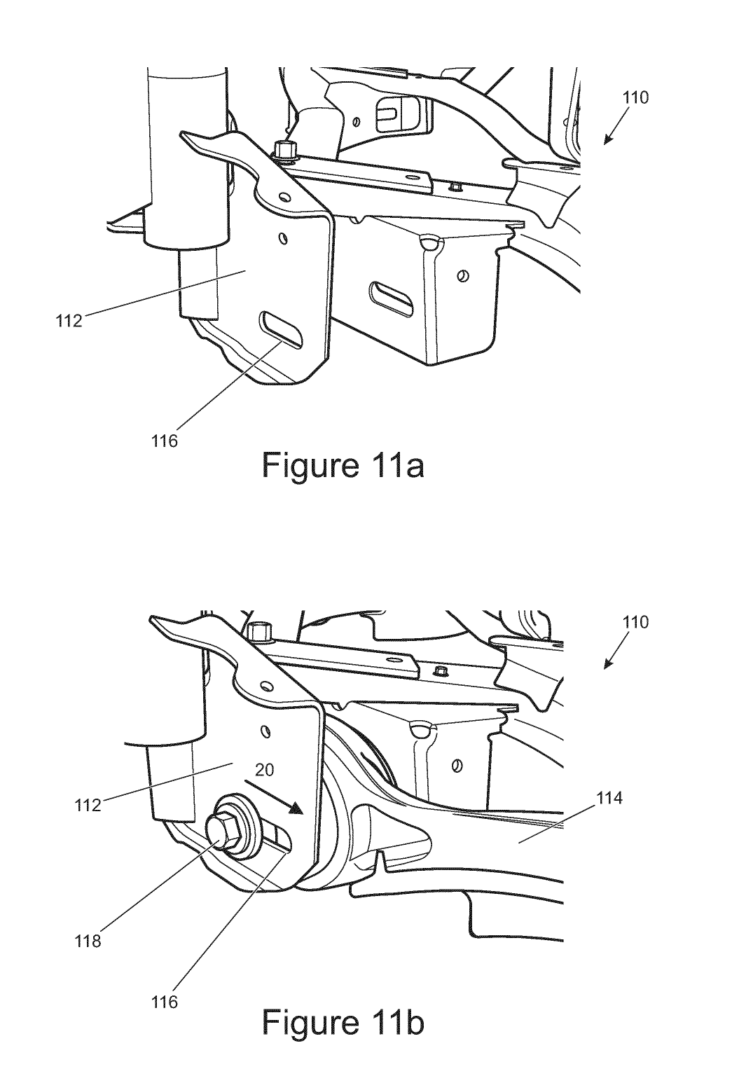

Referring now to FIGS. 11A and 11B, this shows a yet another embodiment of the present in which the vehicle suspension system 110 comprises a frame portion 112 and a control arm 114 (see FIG. 11B). The control arm 114 is arranged to slide relative to the frame portion 112 when the control arm 114 is subjected to loads exceeding a predetermined level. To this end, the frame portion 112 is provided with a slot 116 that receives the control arm 114 and permits sliding movement. The control arm 114 is initially fixed in place relative to the slot 116 by a bolt 118. The clamping force exerted by the bolt 118 retains the control arm 114 in its initial configuration until a threshold force is applied. When the threshold force is applied, the clamping force is overcome, and the control arm 114 slides along the slot 116 in the direction of the arrow 120. As the control arm 114 slides, it absorbs some of the impact of a high-load event, and thus protects other components of the vehicle and suspension system 10 from damage.

The bolt 118 must be fixed in the correct position when the suspension system is initially installed. In this example, the correct position is at the far left side of the slot 116. In the crowded area around a suspension system 110 it can be difficult to visualise the slot 116 and the bolt 118 during assembly, and therefore difficult to arrange the bolt 118 in the correct position in the slot 116. If the bolt 118 is not arranged in the correct position, the geometry set-up for the vehicle would be incorrect, which could lead to vehicle-handling issues, and could cause excessive tyre wear. Furthermore, the bolt 118 may not be able to slide to the full extent that is required, thereby negating the advantageous effect of the slidable suspension arrangement. It would be desirable to provide a means to facilitate location of the bolt 118 in the slot 116.

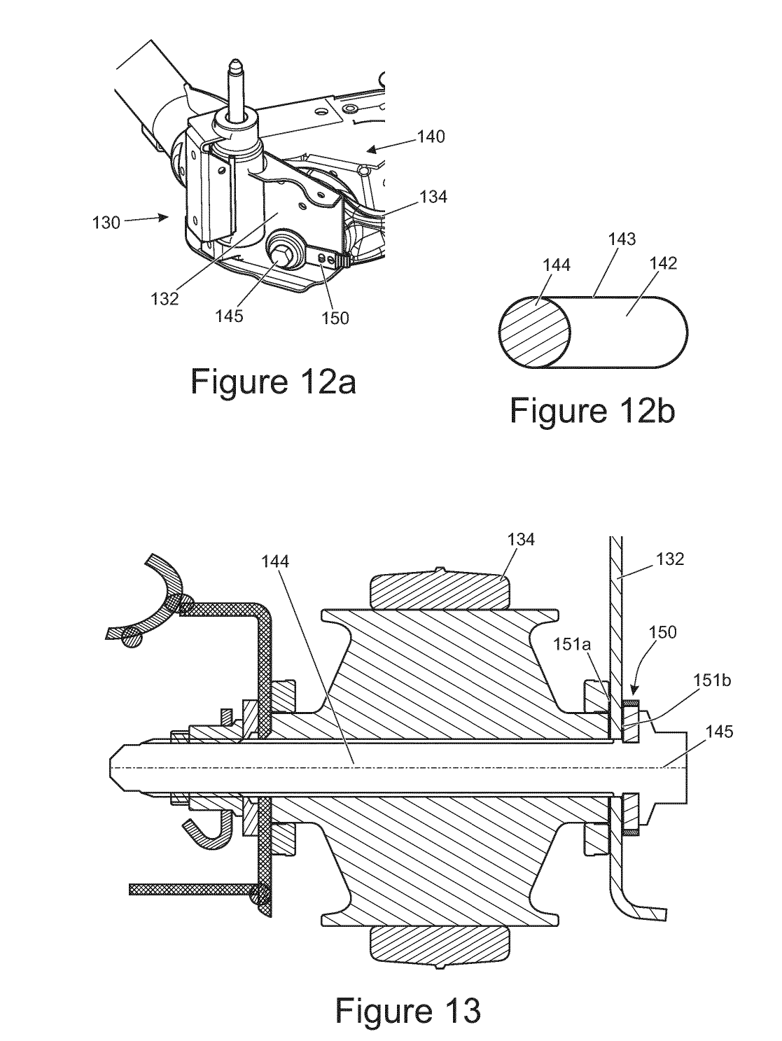

FIGS. 12A and 13 illustrate a vehicle suspension system 130 comprising a joint 140 between a frame 132 and a control arm 34. The frame 132 includes a female element that is shown here as a slot 142 (not visible in FIG. 12A, but visible in FIG. 12B). A male element, shown here as a bolt 145 having a bolt shaft 144, is received in the slot 142, and extends through the control arm 34. The bolt 145 is tightened to fix the bolt shaft 144 in the slot 142, thereby joining the frame 132 to the control arm 34.

FIG. 12B illustrates schematically and in cross section the bolt shaft 144 and the slot 142 and reveals that the bolt shaft 144 has a smaller footprint than that defined by the internal wall 143 of the slot 142. In this way, when the bolt shaft 144 is in the slot 142, a portion of the slot 142 remains open, to permit a degree left-to-right sliding movement of the bolt shaft 144 in the slot 142.

This difference in size between the footprint of the bolt shaft 144 and the footprint of the slot 142 is necessary to permit sliding of the bolt shaft 144 in the slot 142 when required. However, the difference in the size of the footprints also means that when the bolt shaft 144 is initially fixed in place in the slot 142, the bolt shaft 144 could be located in one of several locations relative to the slot 142. In the vehicle suspension system described, the desired location of the bolt shaft 144 at the installation stage is at the far left of the slot 142, as illustrated in FIG. 12B.

Referring back to FIG. 12A, a locator 150 is attached to the frame in the region of the slot 142 to locate the bolt shaft 144 in the correct position in the slot 142 when the bolt 145 is installed. In the embodiment illustrated, the correct position is the desired position along the length of the slot 142. As is visible in FIG. 13, when the locator 150 is arranged for use, a first or inner surface 151a of the locator 150 lies against the frame 132, while a second or outer surface 151b is exposed to the surroundings.

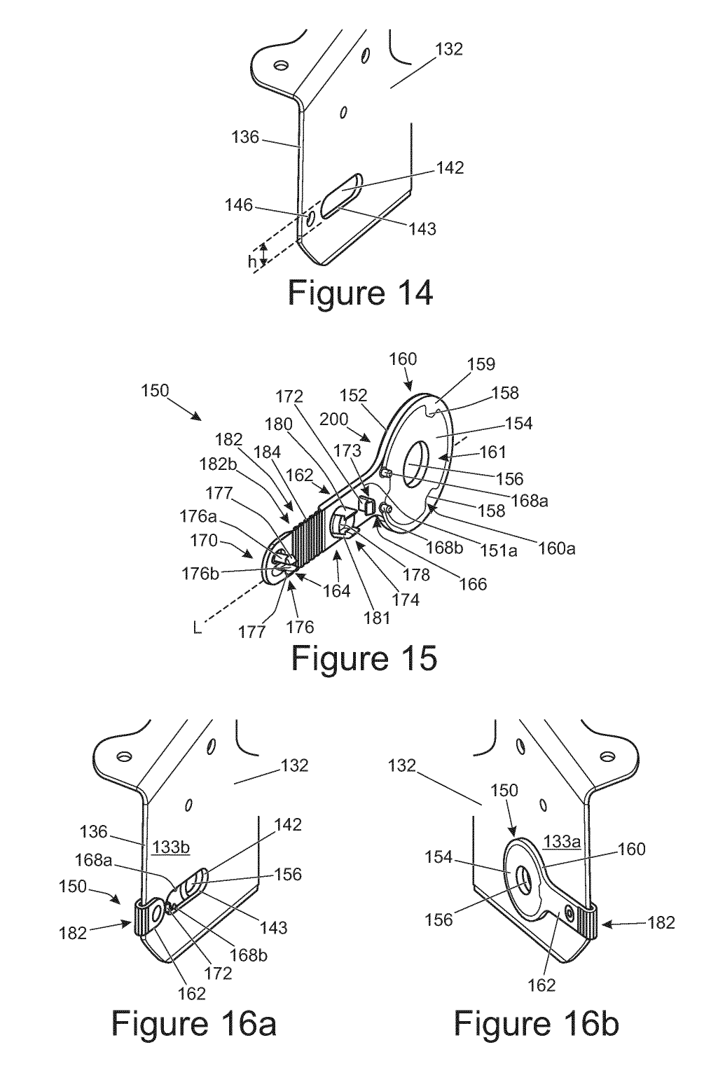

FIG. 14 illustrates the frame 132 in isolation. The slot 142 is disposed close to an edge 136 of the frame 132 and defines an internal wall 143 in the frame 132. An aperture 146 is disposed in the frame 132 in the vicinity of the slot 142, between the slot 142 and the edge 136 of the frame 132. The aperture 146 forms part of an attachment means that, when the locator 150 is in use, allows the locator 150 to be attached to the frame 132.

The locator 150 is illustrated in isolation in FIG. 15. The locator 150 comprises a reinforcing element in the form of an inner disc 154 and an outer frame 152 that supports the inner disc 154.

The inner disc 154 acts as a washer between the bolt 145 and the frame 132 when the locator 150 is in use (see FIG. 13). The inner disc 154 is made of a material that is hard enough to permit tightening of the bolt 145 around the aperture without significant deformation of the disc 154, and without affecting the joint integrity. For example, the disc 154 may be made of steel or any other suitable material.

An aperture 156 in the inner disc 154 receives the bolt shaft 144 when the locator 150 is in use. The footprint of the aperture 156 of the locator 150 is smaller than the footprint defined by the internal wall 143 of the slot 142 of the frame 132. In particular, the aperture 156 of the inner disc 154 is sized and shaped substantially as the cross-section of the bolt shaft 144, such that the bolt shaft 144 fits snugly in the aperture 156 when the locator 150 is in use.

The outer frame 152 is moulded from a plastics material and comprises a circular annulus portion 160 that houses the inner disc 154 and an elongate tab portion 162. The inner disc 154 is incorporated into the outer frame 152 by over moulding the outer frame 152 around the inner disc 154.

The tab portion 162 includes a locating and attachment means 164 for locating the locator 150 in a desired position relative to the slot 142 of the frame 132, and for attaching the locator 150 to the joint in the vicinity of the slot 142 in a push fit, as will be described later.

Considering the annulus portion 160 of the frame 152, the annulus portion 160 defines an aperture 161 that houses the disc 154. An inner diameter of the annulus 160, and hence a diameter of the aperture 161, is substantially the same as an outer diameter of the disc 154. On the inner side 160a of the annulus portion 160, tabs 158 extend inwardly from the annulus 160 towards a centre of the aperture 161 to define a partial rim around the aperture 161. The tabs 158 are flush with the face of the disc 154. Providing tabs in this way means that the disc 154 can be fitted into the annulus portion 160 of the frame 152 by means of a simple push-fit in the direction of the arrow 100. The tabs 158 prevent the disc 154 being pushed out of the frame 152.

Turning now to the tab portion 162 of the frame 152, the tab portion 162 comprises an elongate strip of material that meets the annulus portion 160 at a neck 166 and extends outwardly to an end 170 that is remote from the neck 166. Near the neck 166, retaining means in the form of first and second lugs 168a, 168b protrude from the inner surface 151a of the locator 150. The lugs 168a and 168b are arranged one-above-the-other, with an upper lug 168a towards an upper edge of the tab 162 and a lower lug 168b towards a lower edge of the tab 162. A spacing between the lugs 168a, 168b is slightly smaller than a height h of the slot 142 of the frame 132 (see FIG. 14).

Moving away from the neck 166 and towards the end 170 of the tab 162, a third lug 172 protrudes from the inner surface 151a of the locator 150. The third lug 172 is disposed on a central longitudinal axis L of the tab 162. The third lug 172 comprises a hook formation 73 that faces away from the annulus portion 160 and towards the end 170 of the tab 162.

Continuing further towards the end 170 of the tab 162, two complementary attachment formations 174, 176 that constitute the locating and attachment means 164 of the locator 150 are disposed on the central axis L of the tab 162.

A first or female attachment formation 174 is disposed towards the third lug 172, while a second or male attachment formation 176 is disposed towards the end 170 of the tab 162.

The female attachment formation 174 comprises a circular aperture 178 and a partial collar 180 that protrudes from the inner surface 151a of the locator 150 and surrounds the aperture 178. At an upper edge of the partial collar 180 is an internal rim 181 that faces towards the outer surface 151b of the locator 150.

The male attachment formation 176 comprises a pair of lugs 176a, 176b, each having a hook formation 177. The hook formations 177 of the lugs 176 are outwardly- and oppositely-facing, so as to engage with the internal rim of the partial collar 180 of the female attachment formation 174 when the first and second attachment formation 174, 176 are engaged.

Between the male and female attachment formation 174, 176 is a flexible portion 182 of the tab 162. The flexible portion 182 is thinner than the remainder of the tab 162 to permit flexibility. An outer surface 182b of the flexible portion 182 comprises a corrugated section 184. The corrugated section 84 strengthens the flexible portion 182 whilst still permitting flexibility.

The flexibility of the flexible portion ′82 of the tab 162 allows the end 170 of the tab 162 to be folded back against the central portion of the tab 162 to engage the male and female attachment formations 174, 176.

FIGS. 16A and 16B illustrate the locator 150 when it is fixed in place the vicinity of the slot 142 of the frame 132.

The locator 150 is arranged such that the inner surface 151a of the locator 150 lies against the frame 132. The annulus portion 160, the inner disc 154 and a part of the tab 162 that is nearest to the neck 166 lie against a first or outer surface 133a of the frame 132, as seen in FIG. 16B. The female formation 174 of the locating and attachment means 164 of the locator 150 is located in the aperture 146 of the frame 132, such that the partial collar 180 extends into the aperture 146. In this way, the female formation 174 acts as a locating means that locates the locator 150 in a desired position relative to the slot 142.

The flexible portion 182 of the tab 162 is wrapped around an edge 136 of the frame 132, such that a portion of the tab 162 that is towards the end 170 of the tab 150 lies against a second or inner surface 133b of the frame 132, as seen in FIG. 16A. The male formation 176 of the locating and attachment means 164 of the locator 150 is engaged with the female formation 174 of the locating and attachment means 164 of the locator 150 so as to fix the locator 150 in place. To this end, the lugs 176a, 176b, of the male attachment formation 176 are located in the partial collar 180 of the female attachment formation 180, and the hooks 177 of the lugs 176a, 176b engage with the rim 181 of the partial collar 180 to guard against disengagement of the male attachment formation 176 from the female attachment formation 174.

Thus, the male and female attachment formations 174, 176 are engaged through the aperture 146 of the frame 132 to attach the locator 150 to the joint 132.

As is visible in FIG. 16A, when the locator 150 is fixed in place, the lugs 168a, 168b, 172 protrude into the slot 142 of the frame 132.

At the base of the slot 142, the lower lug 168b rests on the internal wall 143 of the slot 142 and prevents the locator 150 from pivoting downwardly about the locating and attachment means 164, 146.

At the top of the slot 142, the upper lug 168a lies slightly below the internal wall 143 of the slot 142. If the locator 150 is displaced upwardly in the course of assembling the joint, the upper lug 168a abuts the internal wall 143 of the slot 142, thereby preventing the locator 150 from pivoting upwardly about the locating and attachment means 164, 146.

In this way, the upper and lower lug 168a, 168b, act as a retaining means that prevents unwanted upward and downward displacement of the locator 150 and thereby fixes the orientation of the locator 150.

The third lug 172 is located at an end of the slot 142 that is nearest the edge 136 of the frame 132. The hook formation 73 of the third lug 172 hooks over the internal wall 143 of the slot 142. The third lug 172 thereby helps to guide the locator 150 into the correct position relative to the slot 142. Furthermore, if the third lug 172 is not located correctly in the slot, the third lug 172 sits instead against the frame 132, such that the female attachment formation 174 cannot protrude fully through the aperture 146, thereby preventing engagement of the male and female attachment formations 174, 176 and signalling to the operator that the locator 150 is not correctly positioned.

The locating and attachment means 146, 164, and the lugs 168a, 168b, 172 therefore prevent movement of the locator 150 relative to the slot 142 when the locator 150 is fixed in place for use. The protruding nature of the lugs 168a, 168b, 172 also ensures that the locator 150 will only sit flush against the frame 142 when the female attachment formation 174 is successfully located in the aperture 146 of the frame 142. In this way, it is not possible for an installer to accidentally fold back the end 170 of the tab 162 to engage the attachment formations 174, 176 without the female attachment formation 174 being located in the aperture 146 of the frame 132.

The locator 150 is configured such that when the locator 150 is attached to the frame 132, the aperture 156 of the locator 150 is aligned with the slot 142 of the frame 132.

Because the footprint of the aperture 156 of the locator 150 is smaller than the footprint of the slot 142 of the frame 132, the locator 150 shields most of the slot 142 of the frame 132, leaving only a part of the slot 142 selectively exposed for insertion of the bolt shaft 144 in a desired position.

Expressed another way, the locator 150 restricts the footprint of the slot 142 of the frame 132, to a smaller footprint that is the same size as the footprint of the bolt shaft 144. In this way, the bolt shaft 144 can only be inserted into the slot 142 at a predetermined position.

Thus, the locator 150 locates the bolt shaft 144 at a desired location within the slot 142 when the bolt 145 is installed. In this way, the bolt 145 can be reliably installed in the required location in the joint 132 without the need to visualise the joint 132.

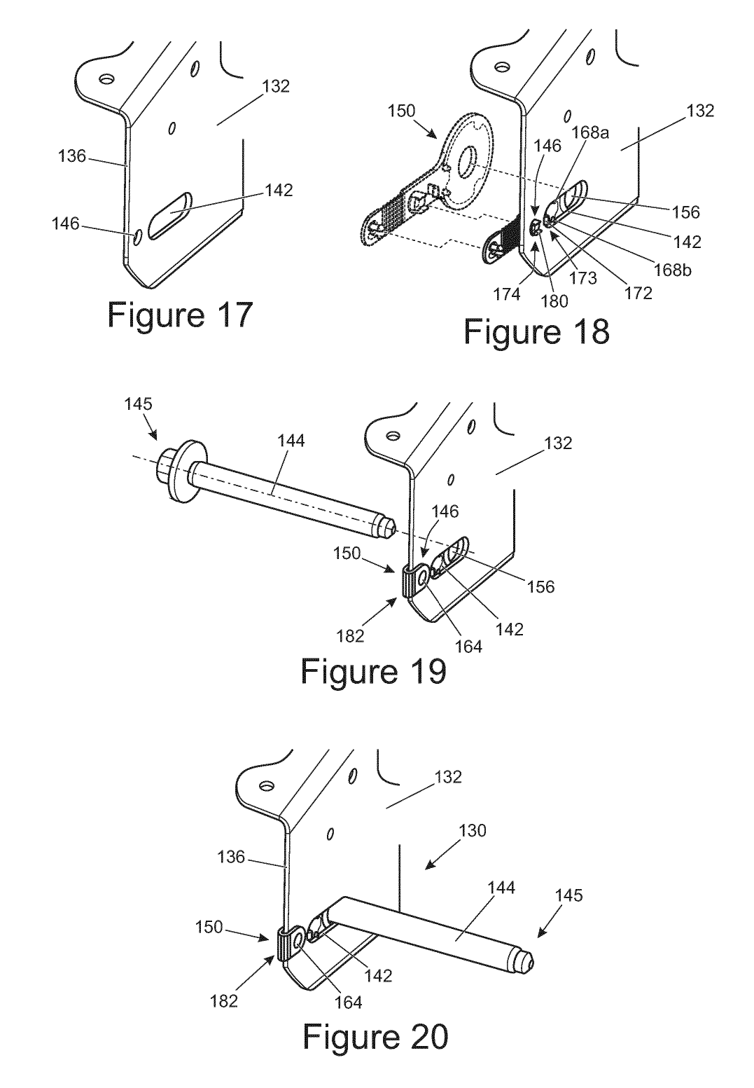

A method of locating the bolt 145 in the slot 142 of the frame 132 using the locator 150 will now be described with reference to FIGS. 17 to 20.

As shown in FIGS. 17 and 18, the locator 150 is firstly arranged against the frame 132. The partial collar 180 of the female attachment formation 174 is located in the aperture 146 of the frame to position the locator in the correct position. The lugs 168a, 168b, 172 are located in the slot 142, with the hook formation 73 of the third lug 172 hooked over the slot 142.

The aperture 156 of the locator 150 is located over the slot 142, so as to define the point of insertion of the bolt shaft 144.

Referring to FIG. 19, the flexible portion 82 of the tab 162 is wrapped around the edge 136 of the frame 132 and the locating and attachment means 164 of the locator 150 are engaged with one another through the aperture 146 of the frame so as to fix the locator 150 in the vicinity of the slot 142.

Next, as shown in FIG. 20, the bolt shaft 144 is inserted through the aperture 156 of the locator 150 and into the slot 142 at the desired location, thereby forming the joint 130. The bolt 145 is tightened against the locator 150, such that the inner disc 154 acts as a washer.

The clamping force exerted by the bolt 145 on the frame 132 surrounding the slot 142 keeps the bolt shaft 144 in the required place in the joint when the suspension mechanism is under normal operating conditions. When a high-load event occurs, and a high force is exerted on the suspension mechanism, the clamping force is overcome. The high force also causes the locating and attachment means 164 of the locator 150 to disengage, such that the bolt shaft 144 and the locator 150 can slide relative to the slot 142, away from the desired location, to absorb some of the impact of the high load event.

Thus, the invention provides a simple means of locating the bolt shaft 144 in a desired location relative to the slot 142 in a joint 130 during the initial installation stage, whilst still allowing the bolt shaft 144 to slide within the slot 142 away from that desired location when a high-load event occurs.

Although the embodiment described relates to a joint in a vehicle suspension mechanism, the joint may be any suitable type of joint in any mechanism or structure in which a male element must be located in a location relative to a female element. For example, the joint could be another type of joint in a vehicle, or it could be a joint in a flat-pack furniture structure.

The male and female elements need not be a bolt and a slot, but may be of any suitable construction in which the male element has a smaller footprint than the female element. For example, the female element may be a circular aperture that has a larger diameter than the diameter of a cross-section of the male element. The female element may be a recess rather than an aperture, and may be of any suitable shape. The male element need not be a bolt but may be a screw, rod, peg, dowel or any other suitable component that can be inserted into a female element.

The annular frame and the inner disc of the locator need not be separate components, but may instead be integrally formed. The aperture of the locator may be any shape and size that is suitable for receiving a male element.

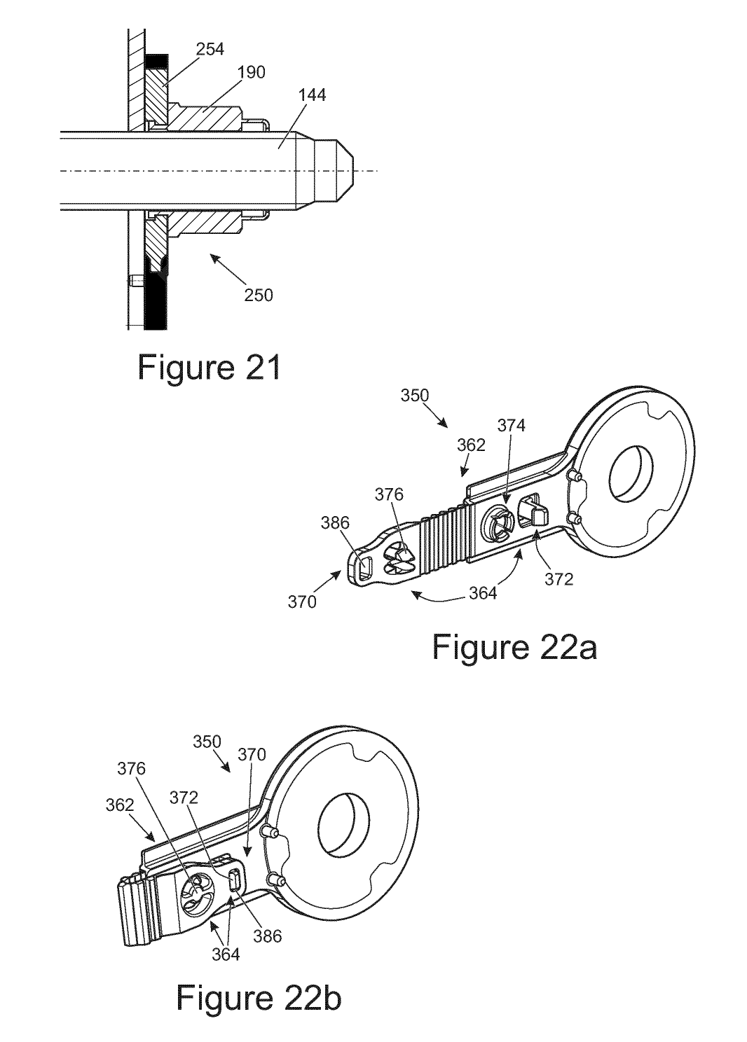

The locator may include a female element supported by or incorporated into it. In this case, the female element defines the aperture of the locator. The female element may be, for example, a nut. FIG. 21 illustrates such a locator 250, in which a nut 190 is fixed to the inner disc 254. In use, the bolt 144 extends through the nut 190.

The locating and attachment means of the locator and the frame need not take the form described but may be any suitable locating and attachment means. For example, the frame may comprise a male or female attachment formation of any suitable construction and the locator may comprise respectively a corresponding female or male attachment formation that is cooperable with the male or female attachment formation of the frame. Other suitable locating and attachment means may also be employed, such as, for example, magnets.

Separate locating means and attachment means may be provided, such that the locator comprises both a locating means and an attachment means. For example, a projection or detent on the locator may act as a locating means that positions the locator relative to the female element, and a separate attachment formation may attach the locator to the joint in the vicinity of the female element. In other examples, the attachment means may be omitted, such that the locator comprises a locating means, and does not include an attachment means.

In a locator 350 illustrated in FIGS. 22A and 22B, the third lug 372 of the tab 362, and an additional female attachment formation that is provided in the form of an aperture 86 located towards the end 370 of the tab 362, also form a part of the locating and attachment means 364 of the tab 362. When the end 370 of the tab 362 is folded back against the central portion of the tab 362, as shown in FIG. 22B, the third lug 372 and the aperture 386 engage, in addition to the engagement between the male and female attachment formations 374, 376.

In this embodiment, the aperture 386 can only engage with the third lug 372 of the tab 362 if the third lug 372 is correctly located in the slot, such that the third lug 372 protrudes through the slot so as to be exposed for engagement with the aperture 386. Thus, the locator 350 can only be attached in place once it has been successfully located in the required position.

It will be appreciated by a person skilled in the art that the invention could be modified to take many alternative forms without departing from the scope of the appended claims.

1. A locator for positioning a male element relative to a female element in a joint, the male element having a smaller footprint than the female element, the locator comprising:
an aperture for receiving the male element, the aperture having a smaller footprint than the female element;
a locating arrangement configured to position the locator relative to the female element of the joint such that the aperture of the locator selectively exposes only a part of the female element to ensure location of the male element within the female element in a desired position; and
an attachment formation configured to attach the locator to the joint, and wherein the attachment formation is configured to detach on application of a threshold force.

2. The locator of claim 1, wherein the locating arrangement is also the attachment formation.

3. The locator of claim 1, wherein the locating arrangement comprises a protrusion for locating in an aperture or recess disposed in a vicinity of the female element.

4. The locator of claim 1, wherein the locator comprises retaining features for fixing an orientation of the locator with respect to the female element.

5. The locator of claim 4, wherein the retaining features are lugs that extend into the female element when the locator is in use.

6. The locator of claim 1, wherein the attachment formation comprises cooperable attachment formations.

7. The locator of claim 6, wherein the cooperable attachment formations are engageable via a push fit.

8. The locator of claim 6, further comprising a flexible portion disposed between the cooperable attachment formations.

9. The locator of claim 8, wherein at least a part of the flexible portion is thinner than a remainder of the locator, and/or wherein the flexible portion comprises a corrugated section.

10-11. (canceled)

12. The locator of claim 1, wherein the locator comprises a reinforcing part around the aperture.

13-16. (canceled)

17. A joint comprising:
a female element,
a male element received in the female element, the male element having a smaller footprint than the female element; and
a locator having an aperture for receiving the male element, the aperture having a smaller footprint than the female element;
wherein a locating arrangement of the locator cooperates with a locating arrangement in a vicinity of the female element, whereby the locator is positioned such that the aperture selectively exposes a part of the female element so as to locate the male element in a desired location relative to the female element in the joint,
wherein the locating arrangement in the vicinity of the female element is provided on a frame that supports the female element, and wherein the locator comprises an attachment formation for attaching the locator to the frame.

18. The joint of claim 17, wherein the female element is a slot, and/or wherein the locating arrangement in the vicinity of the female element is an aperture provided in the frame.

19-21. (canceled)

22. The joint of claim 17, wherein the locating arrangement of the locator acts as the attachment formation.

23. The joint of claim 17, wherein the locating arrangement in the vicinity of the female element acts as an attachment formation for receiving the attachment formation of the locator.

24. (canceled)

25. The joint of claim 17, wherein the joint is a joint in a suspension system of a vehicle.

26. (canceled)

27. A vehicle suspension system, comprising:
a suspension joint; and
a control arm mounted at a first end to a frame portion of the vehicle and at a second end to the suspension joint,
wherein at least a portion of the control arm is arranged to slide relative to the frame portion when the control arm is subjected to loads exceeding a predetermined level, the system further comprising a retaining member configured to prevent the control arm from sliding relative to the frame portion when the control arm is subjected to loads below the predetermined level.

28. The suspension system of claim 27, wherein the retaining member comprises a locator.

29-30. (canceled)

31. A method of assembling a joint using the locator of claim 1, the method comprising:
arranging the locator such that the aperture of the locator selectively exposes a portion of the female element;
attaching the locator to the joint; and
inserting the male element into the female element through the aperture of the joint locator.

32. The method of claim 31, further comprising attaching the locator to the joint before inserting the male element into the female element through the aperture of the joint locator.

33-35. (canceled)
